(19) United States
(12) Patent Application Publication
(10) Pub. No.: US 2026/0034517 A1
(43) Pub. Date: Feb. 5, 2026

(54) COVALENT ORGANIC FRAMEWORKS ON HOLLOW FIBRE SUBSTRATES WITH JANUS-LIKE CHARACTERISTICS FOR SOLVENT SEPARATION

(71) Applicant: National University of Singapore, Singapore (SG)

(72) Inventors: Zhuofan Gao, Singapore (SG); Tai-Shung Chung, Singapore (SG)

(73) Assignee: National University of Singapore, Singapore (SG)

(21) Appl. No.: 18/843,943

(22) PCT Filed: Mar. 7, 2023
(86) PCT No.: PCT/SG2023/050136

§ 371 Date: Sep. 4, 2024

(30) Foreign Application Priority Data
Mar. 7, 2022 (SG) 10202202255S

(51) Int. Cl. B01D 69/12; B01D 61/02; B01D 69/02; B01D 69/08; B01D 69/14; B01D 71/64

(52) U.S. Cl. CPC B01D 69/125; B01D 61/027; B01D 69/02; B01D 69/082; B01D 69/14111; B01D 71/64; B01D 2325/02833; B01D 2325/20; B01D 2325/34; B01D 2325/36; B01D 2325/38

(57) ABSTRACT

The precise molecular sieving architectures with Janus-like characteristics via an interpenetrating polymer network combining the hydrophilic cPI polymer and hydrophobic microporous covalent organic framework (COF) exhibit super-high permeances for both polar and nonpolar solvents. A unidirectional diffusion and convection process significantly speeds up chemically stable COFs with uniform and tailorable channels growing on polymeric hollow fibre that can efficiently separate organic solvents under ultrafiltration conditions.

### FIELD OF INVENTION

The current invention relates to a composite membrane material comprising covalent organic frameworks suitable for use in solvent separation, as well as methods of use and formation.

### BACKGROUND

The listing or discussion of a prior-published document in this specification should not necessarily be taken as an acknowledgement that the document is part of the state of the art or is common general knowledge.

Organic solvents have been widely used in various industries, especially in the fields of chemical, pharmaceutical, and food manufacturing. Organic solvent nanofiltration (OSN) has gained great attention in the last two decades to meet the global demands of recycling solvents, reusing valuable intermediate materials, and minimization of energy consumption in separation processes. OSN aims to separate small molecules with a molecular weight ranging of 200-1000 gmol⁻¹ from organic solvents. Amongst various commercially available OSN membranes, polymer-based membranes are the most popular due to their low costs, excellent processability and ease of scale-up. Many polymeric materials have been developed for the preparation of OSN membranes, including polypropylene (PP), polyether ether ketone (PEEK), polyphenylenesulfone (PPSU), sulfonated PPSU (sPPSU), polyimide (PI), polyacrylonitrile (PAN), polybenzimidazole (PBI) and polydimethyl siloxane (PDMS). Among them, polyimides are the leading materials because their cross-linked membranes have outstanding resistance against a broad range of solvents and good mechanical stability. However, they still have some drawbacks: (1) low flux because of the intrinsic trade-off relationship between solvent permeability and solute rejection, (2) lack of a sharp pore size distribution for precise molecule separation, and (3) weak interactions between membrane materials and organic solvents, resulting in low fluxes for certain organic solvents.

Since covalent organic framework (COF) materials have unique features of well-defined porosities with highly ordered channels in the range of 1-5 nm, high permeability and excellent thermal properties, the combination of COFs with polymeric or ceramic membranes may result in membranes with synergistically enhanced solvent permeability and solute retention for OSN applications. Shi and co-workers grew crystalline imine-based COFs layers on ceramic substrates and showed much enhanced molecular sieving capabilities and additional hydrophilic channels for water transport (J. Membr. Sci., 2019, 576, 116-122). Intriguingly, the duration to form their nanofiltration-level membranes under 100° C. was only 40 minutes, which was much faster than other methods (i.e., it usually took 3 days (Chemical Communications, 2015, 51, 15562-15565). Additionally, an anodic aluminium oxide substrate with an average pore size of less than 20 nm was recommended because the mesoporous supports would promote the growth of defect-free COF films. Wang et al. prepared COFs-based membranes by employing a unidirectional diffusion synthesis of imine-base COFs on polyvinylidene fluoride (PVDF) substrates at room temperature (J. Membr. Sci., 2019, 586, 274-280). The resultant COF composite membranes formed within 24 hours possessed not only superior dye retention but also appreciable water permeance. Liu et al. synthesized a series of continuous free-standing COF membranes with super-high solvent permeances via the liquid-liquid interface-confined reaction (Sci. Adv., 2020, 6, eabb1110). They found that the imine-linked COF membrane exhibited higher nonpolar solvent permeances than the β-ketoenamine-linked COF one because the former had lower polar inner cavities than the latter.

In comparison to flat sheet membranes, hollow fibre membranes (HFMs) possess many advantages, such as a larger membrane surface-to-volume ratio, a smaller footprint and self-supporting characteristics. Despite these advantages, up to now, there are no commercially available HFMs for OSN (Chem. Soc. Rev., 2008, 37, 365-405; J. Membr. Sci., 2019, 588, 117202). So far, most studies on solvent-resistant nanofiltration membranes were dedicated to flat sheet membranes, and only very limited reports were focused on hollow fibres (Chem. Eng. Sci., 2015, 129, 232-242; J. Membr. Sci., 2017, 542, 289-299; Chem. Eng. J., 2018, 345, 174-185; Adv. Membr., 2021, 1, 100007; Sep. Purif. Technol., 2022, 285, 120322). Based on the studies of graphene oxide (GO) composite hollow fibres, it was found more difficult to form a selective layer intimately adherent on round hollow fibre substrates than on flat sheet ones with a comparable separation efficiency (J. Membr. Sci., 2020, 606, 118006; Desalination, 2015, 371, 78-87).

Therefore, the primary objective is to utilize the highly ordered COF structures for the construction of a COF/cPI interpenetrating polymer network (IPN) with sharp molecular sieving capability. This patent presents the design and fabrication of high-flux solvent-resistant HFMs that can overcome the aforementioned problems because (i) COF possessing uniform pores can precisely discriminate molecules of different sizes, (ii) imine-linked COF containing abundant benzene and methylene groups can offer low polar inner cavities, and (iii) the strong π-π interaction between cPI and COF molecules and the formation of an IPN can enhance mechanical properties. A unidirectional diffusion and convection process was employed to form the composite membranes so that the COFs and the porous substrates could intimately adhere to each other and form an IPN with sharp molecular sieving capability and robust mechanical properties. FIG. 1 illustrates the synthesis of COFs via a unidirectional diffusion and convection process on cross-linked polyimide (cPI) hollow fibre supports. An imine-linked COF made of benzene-1,3,5-tricarboxaldehyde (BTCA) and tris(4-aminophenyl)amine (TAPA) was chosen because its low polar inner cavities could perform as superhighways for nonpolar solvent transport. In contrast, a cPI substrate was employed because its original imide bonds had been converted to amide bonds with high hydrophilicity suitable for polar solvent transport. Thus, the existence of both hydrophobic and hydrophilic pores (i.e., Janus characteristics) in the newly developed HFMs could provide microchannels with impressively high permeances for both polar and nonpolar solvents. In addition, the cross-linking reaction between the amine groups of cPI and the aldehyde groups of BTCA would tighten the substrate pores in a meso-range to form desirable HFMs for organic solvent separation.

Apart from the fundamental study of the fabrication of COF/cPI composite HFMs, the solvent separation performance of the resultant HFMs were examined by (i) filtration of various polar, non-polar and aprotic solvents and (ii) separation of five different organic solutes with distinct molecular structures in isopropanol (IPA). In addition, a 175-hour filtration test and a 7-day solvent immersion test were conducted to evaluate membrane stability. This may be the first attempt to molecularly design Janus-type COF composite HFMs for organic solvent separation under a low operating pressure (i.e., ΔP=1 bar). Here we provide insightful strategies to design next-generation high-flux, high energy efficiency and mechanically robust solvent-resistant membranes with superior sieving capability and permeances for a wide range of organic solvents.

### SUMMARY OF INVENTION

Aspects and embodiments of the current invention will now be described by reference to the following numbered clauses.
1. A composite membrane material, comprising:
   a cross-linked polymeric hollow fibre substrate having an inner lumen surface, an outer shell surface and an interior portion between the inner lumen surface and the outer shell surface;
   a plurality of discontinuous covalent organic framework films on the inner lumen surface of the cross-linked polymeric hollow fibre substrate; and
   a plurality of spherical covalent organic framework nanoparticles in the interior portion of the polymeric hollow fibre substrate, wherein:
   the cross-linked polymeric hollow fibre substrate is formed from a polyimide;
   the cross-linked polymeric hollow fibre substrate has an average pore size of 20 nm or less.
2. The composite membrane material according to Clause 1, wherein the covalent organic framework films and the plurality of spherical covalent organic framework nanoparticles are formed from an imine covalent organic framework that is formed from an aldehyde component and an amino component.
3. The composite membrane material according to Clause 2, wherein the aldehyde component is selected from one or more of the group consisting of 1,3,5-triformylbenzene, 1,3,5-tris(p-formylphenyl)benzene, benzene-1,3,5-tricarboxaldehyde, and terephthalaldehyde.
4. The composite membrane material according to Clause 2 or Clause 3, wherein the amino component is selected from one or more of the group consisting of p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, and melamine.
5. The composite membrane material according to any one of Clauses 2 to 4, wherein the aldehyde component is benzene-1,3,5-tricarboxaldehyde (BTCA) and the amino component is tris(4-aminophenyl)amine (TAPA).
6. The composite membrane material according to any one of the preceding clauses, wherein the plurality of spherical covalent organic framework nanoparticles in the interior portion of the polymeric hollow fibre substrate are located in a region that is from 20 to 50 μm, such as from 25 to 35 μm from the inner lumen surface of the cross-linked polymeric hollow fibre substrate.
7. The composite membrane material according to any one of the preceding clauses, wherein the plurality of covalent organic frameworks in the interior portion of the polymeric hollow fibre substrate form an interpenetrating network with the polyimide that forms the cross-linked polymeric hollow fibre substrate.
8. The composite membrane material according to any one of the preceding clauses, wherein the composite membrane material has a water contact angle of from 65 to 100°, such as from 75 to 85°, such as about 77°.
9. The composite material according to any one of the preceding clauses, wherein the composite membrane material has one or more of the following properties:
(a) a molecular weight cut-off of from 500 to 2000 g/mol, such as from 600 to 800 g/mol, such as from 700 to 790 g/mol, such as about 784 g/mol;
(b) a rejection of from 80 to 100% to rose bengal, such as from 93 to 99%, such as from 94 to 95%, such as about 94.9%;
(c) an ethanol permeance of from 50 to 200 L m² h⁻¹ bar⁻¹, such as from 80 to 125 L m⁻² h⁻¹ bar⁻¹, such as from 90 to 100 L m² h⁻¹ bar⁻¹, such as about 98.44 L m² h⁻¹ bar⁻¹;
(d) a methanol permeance of from 50 to 300 L m² h⁻¹ bar⁻¹, such as from 150 to 250 L m⁻² h⁻¹ bar⁻¹, such as from 200 to 240 L m² h⁻¹ bar⁻¹, such as about 224.3 L m⁻² h⁻¹ bar⁻¹;
(e) an acetone permeance of from 100 to 800 L m⁻² h⁻¹ bar⁻¹, such as from 300 to 450 L m⁻² h⁻¹ bar⁻¹, such as from 350 to 400 L m² h⁻¹ bar⁻¹, such as about 395.2 L m² h⁻¹ bar⁻¹;
(f) a hexane permeance of from 50 to 400 L m² h⁻¹ bar⁻¹, such as from 250 to 300 L m⁻² h⁻¹ bar⁻¹, such as from 260 to 280 L m² h⁻¹ bar⁻¹, such as about 266.3 L m² h⁻¹ bar⁻¹;
(g) an isopropyl alcohol permeance of from 30 to 100 L m² h⁻¹ bar⁻¹, such as from 40 to 75 L m² h⁻¹ bar⁻¹, such as from 45 to 50 L m² h⁻¹ bar⁻¹;
(h) a dimethylformamide permeance of from 30 to 120 L m² h⁻¹ bar⁻¹, such as from 65 to 100 L m² h⁻¹ bar⁻¹, such as from 70 to 75 L m⁻² h⁻¹ bar⁻¹;
(i) a tetrahydrofuran permeance of from 150 to 260 L m⁻² h⁻¹ bar⁻¹, such as from 160 to 200 L m² h⁻¹ bar⁻¹, such as from 170 to 175 L m² h⁻¹ bar⁻¹;
(j) an ethyl acetate permeance of from 100 to 300 L m² h⁻¹ bar⁻¹, such as from 225 to 275 L m² h⁻¹ bar⁻¹, such as from 240 to 250 L m² h⁻¹ bar⁻¹;
(k) a toluene permeance of from 80 to 200 L m² h⁻¹ bar⁻¹, such as from 130 to 160 L m⁻² h⁻¹ bar⁻¹, such as from 140 to 150 L m² h⁻¹ bar⁻¹; and
(l) a pore size distribution of from 0.5 to 4.0 nm, such as 1.4 to 2.1 nm, such as 0.5 to 1.5 nm.
10. A method of forming a composite membrane material as described in any one of Clauses 1 to 10, the method comprising:
(a) providing one or more hollow fibres in a hollow fibre module, where each hollow fibre is a cross-linked polymeric hollow fibre formed from a polyimide and has an inner surface, an outer surface and an interior portion between the inner surface and the outer surface;
(b) simultaneously circulating:
   (i) a first solution comprising an organic solvent and a first covalent organic framework precursor through the lumen side of the hollow fibre module (inner surface of each of the hollow fibres), optionally wherein the organic solvent is a 1:1 mixture of dichloromethane and n-hexane; and
   (ii) a second solution comprising water and a second covalent organic framework precursor over the shell side of the hollow fibre module (outer surface of each of the hollow fibres),
      for a period of time to form the composite material.
11. The method according to Clause 10, wherein the first and second covalent organic framework precursors form an imine covalent organic framework, where the first covalent organic framework precursor is a molecule comprising an aldehyde group and the second covalent organic framework precursor is a molecule comprising an amino group.
12. The method according to Clause 11, wherein the molecule comprising an aldehyde group is selected from one or more of the group consisting of 1,3,5-triformylbenzene, 1,3,5-tris(p-formylphenyl)benzene, benzene-1,3,5-tricarboxaldehyde, and terephthalaldehyde.
13. The method according to Clause 11 or Clause 12, wherein the molecule comprising an amino group is selected from one or more of the group consisting of p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, and melamine.
14. The method according to any one of Clauses 11 to 13, wherein the molecule comprising an aldehyde group is benzene-1,3,5-tricarboxaldehyde (BTCA) and the molecule comprising an amino group is tris(4-aminophenyl)amine (TAPA).
15. The method according to any one of Clauses 10 to 14, wherein the period of time is from 10 minutes to 360 minutes, such as from 30 minutes to 300 minutes, such as from 120 minutes to 240 minutes.
16. The method according to any one of Clauses 10 to 15, wherein the concentration of the first and second covalent organic framework precursors in the first and second solvents, respectively, is from 4 mmol/L to 8 mmol/L, such as about 6 mmol/L, optionally wherein the concentration of the first and second covalent organic framework precursors in the respective first and second solvents is the same.
17. The method according to any one of Clauses 10 to 15, wherein the concentration of the first and second covalent organic framework precursors in the first and second solvents, respectively, is about 6 mmol/L and the period of time is about 240 minutes.
18. A method of using a composite membrane material as described in any one of Clauses 1 to 9 in a process of separating a fluid into a filtrate fluid and a retentate fluid, the process comprising the steps of:
(a) providing a fluid in need of separation to a hollow fibre module comprising a plurality of hollow fibres of the composite membrane material as described in any one of Clauses 1 to 9;
(b) enabling a portion of the fluid to pass through the composite membrane material by applying a pressure differential across the composite membrane material to provide a filtrate fluid and thereby providing a retentate fluid; and
(c) collecting the filtrate fluid and retentate fluids, optionally wherein the pressure differential across the composite membrane material is less than 1 bar.
19. The method according to Clause 18, wherein the fluid to be separated is selected from: an aqueous solution comprising one or more inorganic materials; an aqueous solution comprising one or more organic materials; an aqueous solution comprising one or more inorganic materials and one or more organic materials; a mixture of organic liquids; a mixture of one or more organic liquids and water; a mixture of one or more organic liquids and one or more organic materials; a mixture of one or more organic liquids and one or more inorganic materials; a mixture of one or more organic liquids, one or more organic materials and one or more inorganic materials; a mixture of water, one or more organic liquids and one or more organic materials; a mixture of water, one or more organic liquids and one or more inorganic materials; and a mixture of water, one or more organic liquids, one or more organic materials and one or more inorganic materials.

### DRAWINGS

FIG. 1 depicts in situ growth of covalent organic frameworks (COFs) in HFMs.

FIG. 2 depicts the schematic diagram of the hydraulic hand pump to test the burst pressure of hollow fiber membranes

FIG. 3 depicts field-emission scanning electron microscope (FESEM) images of (a) the cPI hollow fibre substrate, and (b) the in situ grown COF/cPI HFM after 240-minute synthesis using 8 mmol/L reactant concentrations of TAPA and BTCA in the shell and lumen sides.

FIG. 4 depicts characterizations of a free-standing COF film, cPI membranes before and after 240-minute COF synthesis under 8 mmol/L reactant concentration, including (a) X-ray diffraction (XRD) patterns, (b) surface water contact angles, and (c) zeta potential vs. pH.

FIG. 5 depicts degrees of swelling after immersing the 8M-COF-240 HFMs in various solvents for (a) 1 hour and (b) 7 days.

FIG. 6 depicts evolution of membrane morphology of COF/cPI composite HFMs as a function of reaction duration (10, 30, 120, and 240 minutes) using 8 mmol/L reactant concentrations of TAPA and BTCA.

FIG. 7 depicts (a) pure ethanol (EtOH) permeance; (b) separation performance of COF/cPI HFMs in EtOH; and (c) pore size distribution, mean effective pore diameter (Up) and geometric standard deviation (Op) of the pristine cPI substrate and 8M-COF HFMs as a function of reaction duration.

FIG. 8 depicts rejection of polyethylene glycols (PEGs) and polyethylene oxides (PEOs) of different molecular weights by the pristine cPI substrate membrane and 8M-COF HFMs as a function of reaction duration.

FIG. 9 depicts FESEM images of COF/cPI HFMs synthesized under different reactant concentrations: 4, 6 and 8 mmol/L for (a) 30-minute and (b) 240-minute syntheses at room temperature.

FIG. 10 depicts (a, c) pure EtOH permeance and (b, d) separation performance of COF/cPI HFMs under different reactant concentrations: 4, 6 and 8 mmol/L for 30-minute and 240-minute syntheses.

FIG. 11 depicts (a) rejections of 6M-COF-240 towards dyes with various molecular weights; (b) ultraviolet-visible (UV-Vis) absorption spectra of the mixed-solute solutions before and after filtration through 6M-COF-240; pure solvent permeances of 6M-COF-240 as a function of (c) solvent type and species and (d) solvent properties in terms of MVₛηₛ⁻¹; (e) 175-hour solvent separation performance of 6M-COF-240.

### DESCRIPTION

In a first aspect of the invention, there is disclosed a composite membrane material, comprising:
a cross-linked polymeric hollow fibre substrate having an inner lumen surface, an outer shell surface and an interior portion between the inner lumen surface and the outer shell surface;
a plurality of discontinuous covalent organic framework films on the inner lumen surface of the cross-linked polymeric hollow fibre substrate; and
a plurality of spherical covalent organic framework nanoparticles in the interior portion of the polymeric hollow fibre substrate, wherein:
the cross-linked polymeric hollow fibre substrate is formed from a polyimide;
the cross-linked polymeric hollow fibre substrate has an average pore size of 20 nm or less.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “a hollow fibre” includes two or more such hollow fibres.

A hollow fibre module will have an inner lumen and an outer shell. As such, the hollow fibre substrate has an inner surface and an outer surface, with an interior portion that connects the inner and outer surfaces together.

As noted herein, a plurality of discontinuous covalent organic framework films form on the inner surface of the cross-linked polymeric hollow fibre substrate. These films may be regular or, more particularly, irregular in size and/or shape. The discontinuous covalent organic framework films may be in the form of polycrystals.

As noted herein, a plurality of spherical covalent organic framework nanoparticles are formed within the interior portion of the polymeric hollow fibre substrate, that is inside the cross-section of the hollow fibre polymer matrix and may be particularly formed near the inner surface of the hollow fibre substrate. These spherical covalent organic framework nanoparticles may be in the form of polycrystals. The covalent organic framework nanoparticles may have any suitable size. For example, the covalent organic framework nanoparticles may have a size of from 200 to 600 nm, such as 300 to 500 nm.

As noted herein, the covalent organic framework films and the plurality of spherical covalent organic framework nanoparticles may be formed from an imine covalent organic framework that is formed from an aldehyde component and an amino component. Any suitable aldehyde and amino component may be used to form the covalent organic framework films and the plurality of spherical covalent organic framework nanoparticles. Suitable aldehydes and amino components will be polyvalent, that is having 2 or more (e.g. 2, 3, 4, or 5) aldehyde or amine groups, respectively. Examples of suitable aldehydes include, but are not limited to, 1,3,5-triformylbenzene, 1,3,5-tris(p-formylphenyl)benzene, benzene-1,3,5-tricarboxaldehyde, terephthalaldehyde, and combinations thereof. Examples of suitable amino components include, but are not limited to, p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, melamine, and combinations thereof.

In particular embodiments of the invention that may be mentioned herein, the aldehyde component may be benzene-1,3,5-tricarboxaldehyde (BTCA) and the amino component may be tris(4-aminophenyl)amine (TAPA).

As noted above, the plurality of spherical covalent organic framework nanoparticles in the interior portion of the polymeric hollow fibre substrate are generally located near to the inner surface of the inner surface, with none on or near to the outer shell surface of the hollow fibre substrate. Without wishing to be bound by theory, it is believed that this arrangement of the spherical covalent organic framework nanoparticles is due to the method of manufacture of the composite material. In embodiments that may be mentioned herein, the plurality of spherical covalent organic framework nanoparticles in the interior portion of the polymeric hollow fibre substrate may be located in a region that is from 20 to 50 μm, such as from 25 to 35 μm from the inner surface of the cross-linked polymeric hollow fibre substrate.

For the avoidance of doubt, it is explicitly contemplated that where a number of numerical ranges related to the same feature are cited herein, that the end points for each range are intended to be combined in any order to provide further contemplated (and implicitly disclosed) ranges. Thus, in the example above, the plurality of spherical covalent organic framework nanoparticles in the interior portion of the polymeric hollow fibre substrate may be located in a region that is:
from 20 to 25 μm, from 20 to 35 μm, from 20 to 50 μm;
from 25 to 35 μm, from 25 to 50 μm; and
from 35 to 50 μm.

It is believed that the plurality of covalent organic frameworks in the interior portion of the polymeric hollow fibre substrate may form an interpenetrating network with the polyimide that forms the cross-linked polymeric hollow fibre substrate. Thus, in embodiments of the invention the plurality of covalent organic frameworks in the interior portion of the polymeric hollow fibre substrate may form an interpenetrating network with the polyimide that forms the cross-linked polymeric hollow fibre substrate. For example, the covalent organic frameworks are believed to have a honeycomb network structure, while the polyimide is crosslinked to itself. As such, it is believed that the two structures will form a polymeric material comprising two or more networks which are at least partially interlaced on a molecular scale but which are not covalently bonded to each other and cannot be separated unless chemical bonds are broken.

The composite membrane material disclosed herein may have any suitable water contact angle (e.g. as measured by the method set out in the examples section herein). Suitable water contact angles that may be mentioned herein include, but are not necessarily limited to a water contact angle of from 65 to 100°. For example, the water contact angle for the composite membrane material may be from 75 to 85°, such as about 77° or such as 77.69°.

The composite membrane material may exhibit any suitable molecular weight cut-off value. For example the molecular weight cut-off of may be from 500 to 2000 g/mol, such as from 600 to 800 g/mol, such as from 700 to 790 g/mol, such as about 784 g/mol.

Additionally or alternatively, the membrane material may exhibit a rejection of from 80 to 100% to rose bengal, such as from 93 to 99%, such as from 94 to 95%, such as about 94.9%.

Additionally or alternatively, the membrane material may exhibit one or more permeance values for a range of organic solvents. These may include one or more of the following:
(a) an ethanol permeance of from 50 to 200 L m² h⁻¹ bar⁻¹, such as from 80 to 125 L m⁻² h⁻¹ bar⁻¹, such as from 90 to 100 L m² h⁻¹ bar⁻¹, such as about 98.44 L m⁻² h⁻¹ bar⁻¹;
(b) a methanol permeance of from 50 to 300 L m² h⁻¹ bar⁻¹, such as from 150 to 250 L m⁻² h⁻¹ bar⁻¹, such as from 200 to 240 L m² h⁻¹ bar⁻¹, such as about 224.3 L m² h⁻¹ bar⁻¹;
(c) an acetone permeance of from 100 to 800 L m⁻² h⁻¹ bar⁻¹, such as from 300 to 450 L m⁻² h⁻¹ bar⁻¹, such as from 350 to 400 L m² h⁻¹ bar⁻¹, such as about 395.2 L m² h⁻¹ bar⁻¹;
(d) a hexane permeance of from 50 to 400 L m² h⁻¹ bar⁻¹, such as from 250 to 300 L m⁻² h⁻¹ bar⁻¹, such as from 260 to 280 L m² h⁻¹ bar⁻¹, such as about 266.3 L m² h⁻¹ bar⁻¹;
(e) an isopropyl alcohol permeance of from 30 to 100 L m² h⁻¹ bar⁻¹, such as from 40 to 75 L m² h⁻¹ bar⁻¹, such as from 45 to 50 L m² h⁻¹ bar⁻¹;
(f) a dimethylformamide permeance of from 30 to 120 L m⁻² h⁻¹ bar⁻¹, such as from 65 to 100 L m² h⁻¹ bar⁻¹, such as from 70 to 75 L m² h⁻¹ bar⁻¹;
(g) a tetrahydrofuran permeance of from 150 to 260 L m⁻² h⁻¹ bar⁻¹, such as from 160 to 200 L m² h⁻¹ bar⁻¹, such as from 170 to 175 L m² h⁻¹ bar⁻¹;
(h) an ethyl acetate permeance of from 100 to 300 L m² h⁻¹ bar⁻¹, such as from 225 to 275 L m² h⁻¹ bar⁻¹, such as from 240 to 250 L m² h⁻¹ bar⁻¹; and
(i) a toluene permeance of from 80 to 200 L m² h⁻¹ bar⁻¹, such as from 130 to 160 L m⁻² h⁻¹ bar⁻¹, such as from 140 to 150 L m² h⁻¹ bar⁻¹.

Additionally or alternatively, the composite membrane material may exhibit any suitable pore size distribution. For example, the composite membrane material may exhibit a pore size distribution of from 0.5 to 4.0 nm, such as 1.4 to 2.1 nm, such as 0.5 to 1.5 nm.

As demonstrated herein, the composite material may be used to separate two or more molecules in solution (e.g. two organic molecules). The separation of the two or more molecules may be due to differences in molecular weight or, more particularly, their molecular shapes and surface properties (e.g., surface charging, etc.).

The composite material used herein may be formed by a method comprising the following steps:
(a) providing one or more hollow fibres in a hollow fibre module, where each hollow fibre is a cross-linked polymeric hollow fibre formed from a polyimide and has an inner surface, an outer surface and an interior portion between the inner surface and the outer surface; and
(b) simultaneously circulating:
   (i) a first solution comprising an organic solvent and a first covalent organic framework precursor through the lumen side of the hollow fibre module (inner surface of each of the hollow fibres), optionally wherein the organic solvent is a 1:1 mixture of dichloromethane and n-hexane; and
   (ii) a second solution comprising water and a second covalent organic framework precursor over the shell side of the hollow fibre module (outer surface of each of the hollow fibres),
      for a period of time to form the composite material.

Further details of the method used to form the composite membrane material may be found in the examples section hereinbelow.

In embodiments of this method, the first and second covalent organic framework precursors may form an imine covalent organic framework, where the first covalent organic framework precursor may be a molecule comprising an aldehyde group and the second covalent organic framework precursor may be a molecule comprising an amino group. For example, the molecule comprising an aldehyde group may be selected from one or more of the group consisting of 1,3,5-triformylbenzene, 1,3,5-tris(p-formylphenyl)benzene, benzene-1,3,5-tricarboxaldehyde, and terephthalaldehyde. For example, the molecule comprising an amino group may be selected from one or more of the group consisting of p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, and melamine. In particular embodiments of the invention that may be mentioned herein, the molecule comprising an aldehyde group may be benzene-1,3,5-tricarboxaldehyde (BTCA) and the molecule comprising an amino group may be tris(4-aminophenyl)amine (TAPA).

The period of time for the circulation step in the above method may be any suitable amount of time. For example, the period of time may be from 10 minutes to 360 minutes, such as from 30 minutes to 300 minutes, such as from 120 minutes to 240 minutes.

Any suitable concentration of the first and second covalent organic framework precursors in the first and second solvents, respectively, may be used herein. For example, the concentration of the first and second covalent organic framework precursors in the first and second solvents, respectively, may be from 4 mmol/L to 8 mmol/L, such as about 6 mmol/L. The concentration of the first and second covalent organic framework precursors in the first and second solvents may be the same or different. In particular embodiments that may be mentioned herein the concentration of the first and second covalent organic framework precursors in the respective first and second solvents may be the same. For example, the concentration of the first and second covalent organic framework precursors in the first and second solvents, respectively, is about 6 mmol/L and the period of time is about 240 minutes.

In an aspect of the invention there is provided a method of using a composite membrane material as described herein in a process of separating a fluid into a filtrate fluid and a retentate fluid, the process comprising the steps of:
(a) providing a fluid in need of separation to a hollow fibre module comprising a plurality of hollow fibres of the composite membrane material as described herein;
(b) enabling a portion of the fluid to pass through the composite membrane material by applying a pressure differential across the composite membrane material to provide a filtrate fluid and thereby providing a retentate fluid; and
(c) collecting the filtrate fluid and retentate fluids.

Any suitable pressure differential across the composite membrane material may be used in embodiments of the invention. For example, the pressure differential may be any pressure capable of causing separation of the fluids into a filtrate fluid and retentate fluid and so may be a pressure differential of less than 1 bar up to a pressure less than the burst pressure of the composite membrane material (e.g. approximately 21 bar). For example, the pressure differential may be from less than 1 bar to 10 bar.

The fluid to be separated may be any suitable fluid. For example, the fluid to be separated may be selected from: an aqueous solution comprising one or more inorganic materials; an aqueous solution comprising one or more organic materials; an aqueous solution comprising one or more inorganic materials and one or more organic materials; a mixture of organic liquids; a mixture of one or more organic liquids and water; a mixture of one or more organic liquids and one or more organic materials; a mixture of one or more organic liquids and one or more inorganic materials; a mixture of one or more organic liquids, one or more organic materials and one or more inorganic materials; a mixture of water, one or more organic liquids and one or more organic materials; a mixture of water, one or more organic liquids and one or more inorganic materials; and a mixture of water, one or more organic liquids, one or more organic materials and one or more inorganic materials.

The hollow fibre membranes (HFMs) for organic solvent nanofiltration (OSN) disclosed herein may be used using a pressure differential of about 1 bar. This allows the composite membrane material to operate in the methods disclosed herein more efficiently and at a lower cost than flat sheet membranes. Without wishing to be bound by theory, one or more of the following advantages may apply:
(i) a larger membrane surface-to-volume ratio;
(ii) a smaller footprint;
(iii) self-supporting; and
(iv) under ultrafiltration (UF) operating conditions significantly reduce energy consumption and operation costs.

The methodology to manufacture the composite membrane material is easy and scalable, allowing the fast growth of covalent organic frameworks (COFs) with uniform an tailorable channels one polymeric hollow fibre substrate membranes. Advantages associated with this methodology include:
(i) reaction at room temperature and atmospheric pressure;
(ii) compared to the traditional synthesis of COF membranes, much less time (e.g. less than ⅙ duration (i.e., 240 min)) to fabricate the inner-selective COF composite NF hollow fibre membranes (HFMs); and
(iii) the unidirectional diffusion and convection process can be applied similarly to the process of the TFC HFMs fabrication for RO membranes, making this method easy to scale up.

The composite membrane materials disclosed herein exhibit Janus-like characteristics, suitable for use with a wide organic solvents (and their separation). The existence of both hydrophobic (i.e., COFs) and hydrophilic (i.e., cPI) pores (i.e., Janus characteristics) in the composite membrane materials disclosed herein appear to endow them with high permeances for both polar and nonpolar solvents. In some embodiments an optimal hollow fibre membrane may have a molecular weight cut-off (MWCO) of 784 g mol⁻¹, and supreme permeances of MeOH (˜224.3 L m⁻² h⁻¹ bar⁻¹), acetone (˜395.2 m⁻² h⁻¹ bar⁻¹), and hexane (˜266.3 m⁻² h⁻¹ bar⁻¹).

The methodology disclosed herein allows for ease of manipulation of the membrane porous structure. Thus, the aperture size and channel chemistry of COF membranes can be rationally designed by bridging various molecular building blocks via strong covalent bonds, providing the ability for precise molecule separation.

An easy scalable and fast method to grow covalent organic frameworks (COFs) with uniform and tailorable channels on polymeric hollow fibre substrates membranes Aspects and embodiments of the invention will now be described by reference to the following non-limiting examples.

### EXAMPLES

### Materials

The Matrimid® polymer was acquired from Vantico Inc. (USA). Analytic grade N-methyl-2-pyrrolidinone (NMP), diethylene glycol (DEG) and 1,6-hexanediamine (HDA) were purchased from Sigma-Aldrich and used to prepare the hollow fibre substrates. Benzene-1,3,5-tricarboxaldehyde (BTCA), tris(4-aminophenyl)amine (TAPA) and acetic acid (AA) were procured from TCI and Merck, respectively. High-performance liquid chromatography (HPLC) grade dichloromethane (DCM), methanol (MeOH), ethanol (EtOH), isopropanol (IPA), tetrahydrofuran (THF), dimethylformamide (DMF), ethyl acetate, acetone, dimethyl sulfoxide (DMSO), heptane, toluene and hexane were bought from Fisher Scientific and used without further purification. Deionized (DI) water was produced by a Millipore Milli-Q unit. Neutral polyethylene glycols (PEGs) and polyethylene oxides (PEOs) with different molecular weights (M_{W}) from 200 to 100,000 gmol⁻¹, L-α-Phosphatidylcholine (L-α-lecithin, a mixture of phosphatidylcholine and phosphatides, M_{W}=758 gmol⁻¹) and various dyes including rose bengal (RB, M_{W}=1018 gmol⁻¹), fast green FCF (FGF, M_{W}=809 gmol⁻¹), eosin Y (EY, M_{W}=648 gmol⁻¹), Sudan IV (SI, M_{W}=380 gmol⁻¹) and neutral red (NR, M_{W}=289 gmol⁻¹) were ordered from Sigma-Aldrich for membrane characterizations.

### Example 1. Fabrication of Covalent Organic Framework (COF)/Cross-Linked Polyimide (cPI) Hollow Fibre Membranes

### Fabrication of Porous cPI Hollow Fibre Substrates

The single-layer polyimide HFMs were made by a dry-jet wet-spinning process using an advanced coextrusion technology via a dual-layer spinneret as described previously (Chem. Eng. Sci., 2015, 129, 232-242; J. Chem. Eng., 2014, 241, 457-465). The bore fluid, polymer solution and N-methyl-2-pyrrolidinone (NMP) were pumped into the inner, middle and outer channels of a dual-layer spinneret, respectively. After going through an air gap of 3 cm, the extruded fibres entered a water coagulant bath, then the as-spun hollow fibres were collected by a take-up drum. The dope composition, spinning conditions and post treatments were listed in Table 1.

TABLE 1
Summary of dope compositions, spinning conditions and
post treatments of polyimide hollow fibre supports.

| Inner polymer dope solution | 18/16/66 (Matrimid/DEG/ | |
|---|---|---|
| composition (wt %) | NMP) | |
| Outer channel | NMP | |
| Bore fluid solution | 70/30 (H₂O/NMP) | |
| composition (wt %) | | |
| Inner polymer dope flow rate | 3.0 | |
| (mL/min) | | |
| Outer flow rate (mL/min) | 0.5 | |
| Bore fluid flow rate (mL/min) | 2.0 | |
| Air-gap length (cm) | 3.0 | |
| Take-up speed (m/min) | 2.40 (free fall) | |
| External coagulants | Tap water | |
| Spinneret dimension (mm) | Dual-layer spinneret 0.84-1.0-1.58- | |
| | 1.74-2.0 | |
| Spinning temperature (° C.) | Ambient (23° C. ± 2) | |
| Post treatments | 1. | 5/95 wt % HDA/IPA solution |
| | | crosslinking for 24 hours at room |
| | | temperature; |
| | 2. | DMF immersion for 1 day, followed |
| | | by DI water wash; |
| | 3. | 50/50 wt % glycerol/water solution |
| | | impregnation overnight; |
| | 4. | Air drying. |

The nascent hollow fibres were soaked in DI water for 48 hours to remove the residual solvent and DEG. Subsequently, the wet hollow fibre substrates were immersed in a 5/95 wt % HDA/IPA solution with stirring at room temperature for 24 hours, followed by solvent activation by DMF for another day. Lastly, the cPI hollow fibres were washed by DI water four times to remove the remaining chemicals. To avoid the pore collapse, the hollow fibres were impregnated by a 50/50 wt % glycerol/water solution for another 2 days, then air-dried in ambient conditions for further usage.

### Fabrication of Membrane Modules and In Situ Growth of COFs

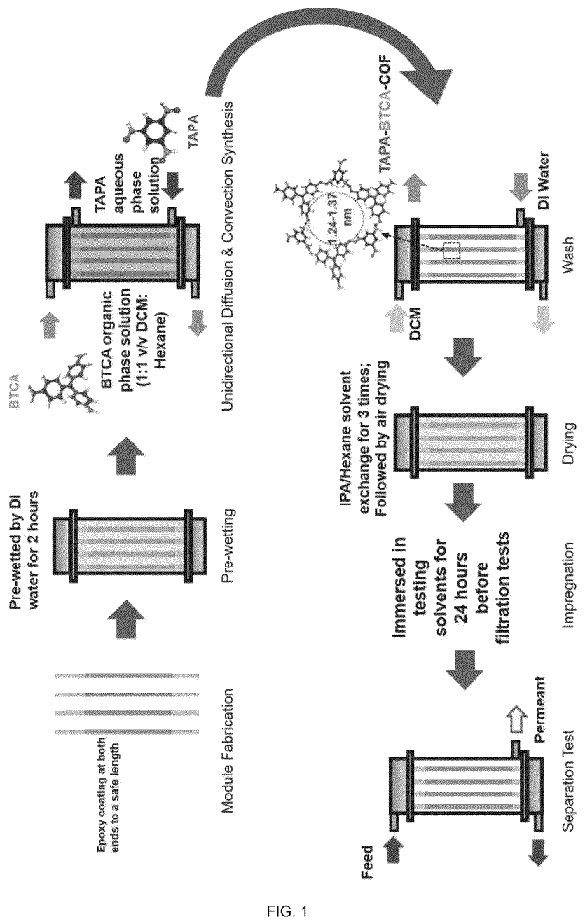

Lab-scale HFM modules containing 4 pieces of cPI hollow fibres with an effective length of 22 cm were fabricated as described above for in situ growth of COFs. The detailed procedures of module fabrication had been documented elsewhere (Chem. Eng. Sci., 2015, 129, 232-242; J. Chem. Eng., 2014, 241, 457-465). Afterwards, the modules were positioned vertically and soaked in deionized (DI) water for 2 hours before COF growth. FIG. 1 illustrates the scheme to synthesize COFs via a unidirectional diffusion and convection process on cPI hollow fibre substrates. Firstly, two types of monomer solutions were prepared; one consisted of BTCA in an organic phase, while the other comprised TAPA and AA (i.e., catalyst) in an aqueous phase. Briefly, transparent BTCA solutions of 0.4, 0.6 and 0.8 mmol were prepared in DCM/hexane mixtures of 100 mL at 1:1 volume ratio, while dark purple TAPA and AA solutions were dissolved in DI water of 100 mL with molar ratios of 0.4:0.24, 0.6:0.36, 0.8:0.48 (in mmol:mmol).

To grow COF in HFMs, a TAPA aqueous solution comprising AA was circulated in the shell side of modules (i.e., the outer surface of HFMs) from the bottom to the top at a flowrate of 5 mL/min for a certain period (i.e., 10 minutes, 30 minutes, 120 minutes and 240 minutes). Meanwhile, a BTCA solution was circulated counter currently on the lumen side of modules (i.e., the inner surface of HFMs) at a flowrate of 1 mL/min. Afterwards, fresh DI water and DCM were re-circulated along the shell and lumen sides respectively to remove the excess residual monomers. Then the resultant membranes were solvent exchanged by three consecutive immersions in IPA followed by hexane, each time lasted for 30 minutes. Finally, membranes were dried in air and stored prior to performance evaluation.

The prepared COF/cPI composite membranes were denoted by xM-COF-y, where x was the molar concentration of either TAPA or BTCA as their molar ratio was always 1:1, while y was the duration (in minutes) of interfacial reaction for COF growth. For instance, 4M-COF-10 indicates the concentrations of TAPA and BTCA are 4 mmol/L in water and DCM/hexane, respectively, and the reaction duration is 10 minutes.

### Example 2. Physicochemical Changes Due to In Situ Grown COFs Incorporation

The physicochemical changes due to in situ grown COFs incorporation as described in Example 1 are presented below.

### Field-Emission Scanning Electron Microscope (FESEM) and Characterisation of COFs

Morphologies of HFMs were observed using a JSM-7610F field-emission scanning electron microscope (FESEM). For cross-section characterizations, dried hollow fibres were fractured in liquid nitrogen and then coated with platinum by an ion sputtering device (JEOL JFC-1300E). The average thickness and crystallite size of the COF structure were calculated based on a statistical analysis of their FESEM images by ImageJ software, five random regions were selected for each FESEM image, and their thickness and crystallite size were measured and calculated average values.

### Atomic Force Microscopy (AFM) for Surface Roughness Examination

The inner-surface roughness of HFMs was examined by atomic force microscopy (AFM, Bruker Dimension ICON) under a scanning rate of 1 Hz, and a NanoScope Analysis 1.40 software was utilized to compute the mean surface roughness. Ten random locations were selected for each sample with a size of 5 cm×1 cm and three independent membranes were examined for each condition.

### X-Ray Photoelectron Spectroscopy (XPS)

X-ray photoelectron spectroscopy (XPS, Kratos AXIS UltraDLD) equipped with a monochromatised Al Kα X-ray source (1486.71 eV, 5 mA, 15 kV) was employed to analyse the chemical structure changes of inner surfaces. Both wide scan and core-level spectra were determined. The core-level signals were obtained at the photoelectron take-off angle (a, with respect to the sample surface) of 90°. Binding energy peaks were all calibrated with reference of neutral Cis hydrocarbon peak at 284.6 eV.

### Fourier Transform Infrared (FTIR) Spectroscopy

Fourier transform infrared spectroscopy (Bio-Rad TFS-3500 FTIR) under an attenuated total reflectance mode over a wavenumber range of 400-4000 cm⁻¹ was employed to analyse the chemical structure changes of inner surfaces of HFMs with a Bruker Vertex 70 spectrometer.

### X-Ray Diffraction (XRD)

The crystal structures of flat sheet cPI supports, free-standing COF films and COF/cPI composite membranes were investigated by a Bruker D8 Advance X-ray diffractometer using Cu Kα as the excitation radiation (λ=0.154 nm) at a current of 30 mA and a voltage of 40 kV.

### Evaluation of Water Contact Angles of Membrane Surfaces

An optical contact angle drop-meter (DataPhysics, OCA25, Germany) was used to evaluate the water contact angles of membrane surfaces at room temperature with a relative humidity of about 30%. Ten random locations were selected for each sample with a size of 5 cm×1 cm and three independent membranes were examined for each condition.

### Determination of Charge Property of Membrane Surfaces

Zeta potential (SurPASS3, Anton Paar, Austria) was analysed as a function of pH to determine the charge property of membrane surfaces through streaming potential measurements flat sheet membranes for each sample with a size of 3 cm×3 cm. The zeta potential of the membranes was first measured with a 0.01 mol/L NaCl solution at neutral pH. Then a 0.1 mol/L HCl and a 0.1 mol/L NaOH were used to adjust the solution pH from pH 2 to pH 11 by auto-titration. Once zeta potential as a function of pH was established, the isoelectric point of the membrane was determined.

### Measurements of Tensile Properties of HFMs

The mechanical properties of the cPI hollow fibre substrate and COF/cPI HFMs were measured using an Instron universal testing system (Model 3342, Instron). The samples were tested with a constant elongation rate of 10 mm/min. The average value of five measurements for each membrane sample with a length of 10 cm was reported.

### Measurements of Burst Strength of HFMs

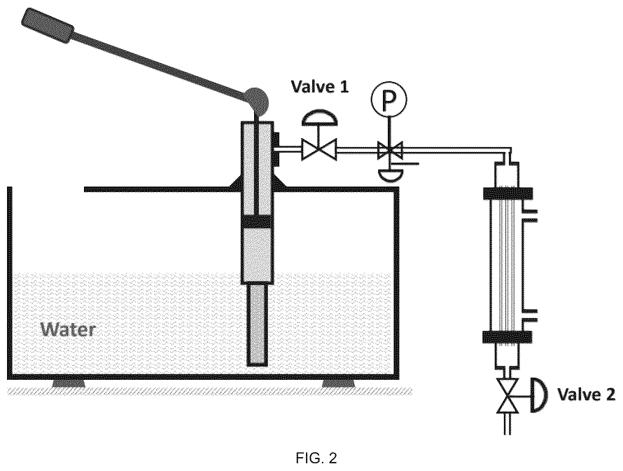

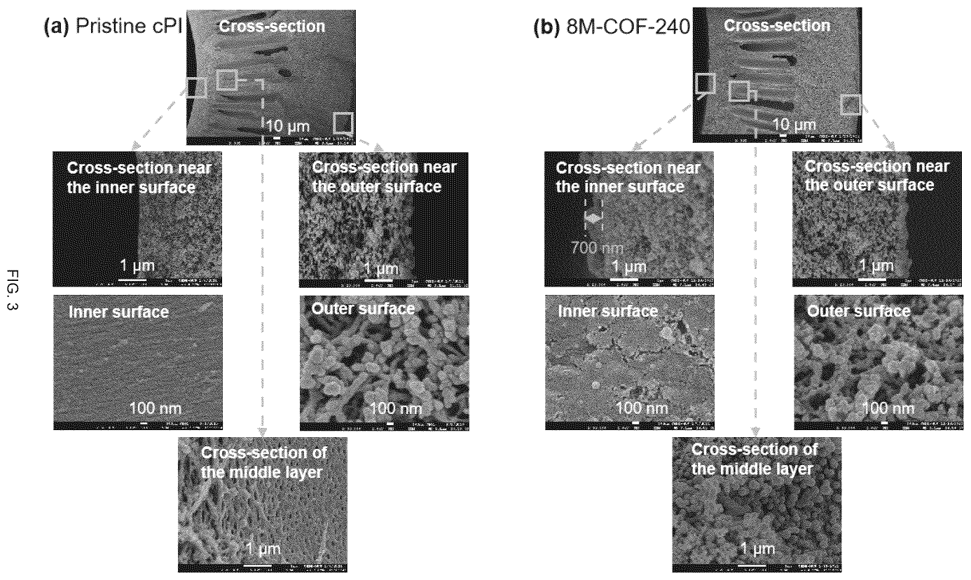

The burst pressure was determined using a manual hydro pressure test pump (KYOWA, Japan; Model: T300NDX, range: 0-300 bar), as described in previous report (Nat. Commun., 2021, 12, 2338). As shown in FIG. 2, the hollow fibre membrane module was connected to the hose of the hand pump. Firstly, the effluent valve 2 was opened so that water was pumped into the lumen side of the fibers to eliminate air. Then the valve 2 was closed, and water was pumped slowly into the hollow fibers. The pressure within the lumen side of the fibers was built up as the driving force was increased by pushing the handle downward with hands. When the gauge pressure suddenly decreased, indicating the burst pressure was reached. Usually, a bursting sound was heard.

### Measurements of Swelling Degree of HFMs

To evaluate the swelling degree of HFMs, three pieces of each membrane were immersed in an organic solvent such as MeOH, EtOH, IPA, THF, DMF, ethyl acetate, acetone, DMSO, heptane, toluene and hexane solvents for certain periods (i.e., 1 hour and 7 days). The degree of swelling was determined by measuring the length difference between a dry (I_{dry}) and a wet HFM (Iₛ) as follows (Eq. (1)).

$$Swelling degree = \frac{{l}_{s} - {l}_{dry}}{{l}_{s}} \times 100 \% \qquad ( 1 )$$

### Results and Discussions

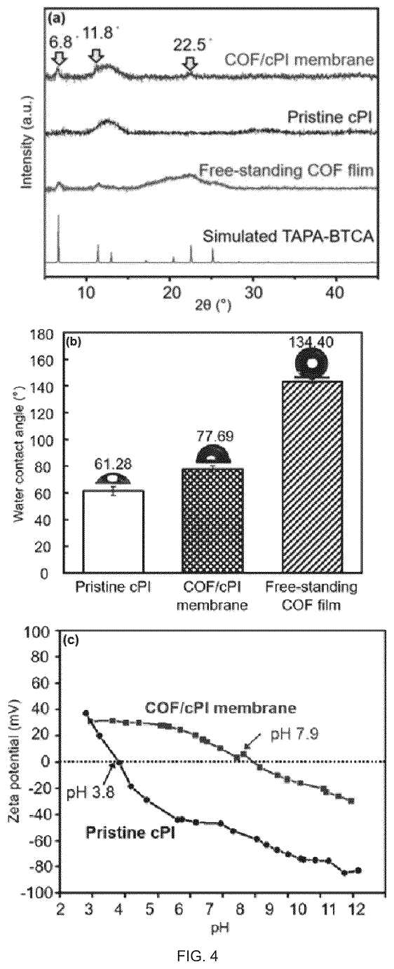

FIG. 3 displays FESEM images of the cPI substrate and the in situ grown COF HFM after 240-minute synthesis using 8 mmol/L TAPA and BTCA solutions to circulate the shell and lumen sides, respectively. Two noticeable polycrystals are formed. Firstly, irregular-shape films appear on the inner surface of the HFM. Secondly, spherical crystallites with a size of 300˜500 nm emerge inside the cross-section of the hollow fibre polymer matrix near the inner surface as an interpenetrating network. However, no crystallite is found on the outer surface. This suggests that the in situ growth of COFs is confined in a thin interface region near the inner surface where BTCA monomers diffuse through the inner surface and react with TAPA in the porous support, leading to the formation of COF crystallites. FIG. 4a compares the XRD patterns of a freestanding COF film, cPI membranes before and after the COF synthesis. The three peaks at 6.8°, 11.8° and 22.5° of the COF/cPI membrane are attributed to the crystal planes of [1 0 0], [1 1 0] and [0 0 1], respectively. Since these peaks match well with standard simulated patterns of TAPA-BTCA, it confirms the formation of 2D honeycomb COF crystal structures (Sci. Adv., 2020, 6, eabb1110; CrystEngComm, 2017, 19, 4899-4904).

Since the presence of C═N and C═C groups in both cPI and COF membranes, XPS analyses were used to further validate the completion of the Schiff-base condensation reaction. As summarized in Table 2, the pristine cPI membrane has an 8.81% O element with an O/N ratio of 1.46. The simulated TAPA-BTCA formula has no O element in the synthesized COF (Sci. Adv., 2020, 6, eabb1110; CrystEngComm, 2017, 19, 4899-4904; J. Am. Chem. Soc., 2017, 139, 1554-1564). Thus, the reductions of O content from 8.81% to 4.83% and O/N ratio from 1.46 to 0.65 for the 8M-COF-240 membrane imply the formation of COFs and a COF/cPI interpenetrating network.

TABLE 2
The theoretical and experimental compositions of the cPI substrate
and COF/cPI composite membranes from XPS analyses.

| | Atomic concentrations (%) | | | O/N element |
|---|---|---|---|---|
| Sample | C | O | N | ratio |
| cPI (from XPS) | 85.17 | 8.81 | 6.02 | 1.46 |
| TAPA-BTCA (theoretical) | 87.1 | 0 | 12.6 | 0 |
| 8M-COF-10 (from XPS) | 85.22 | 7.01 | 7.76 | 0.90 |
| 8M-COF-30 (from XPS) | 85.95 | 5.64 | 8.41 | 0.67 |
| 8M-COF-120 (from XPS) | 86.90 | 5.19 | 7.91 | 0.66 |
| 8M-COF-240 (from XPS) | 87.74 | 4.83 | 7.43 | 0.65 |

The presence of COFs in the cPI substrate also affects the overall surface wettability, surface charge and mechanical properties. As shown in FIG. 4b, the water contact angle becomes higher due to the existence of abundant benzene and methylene groups from TAPA-BTCA molecules. Since the cPI substrate is inherently hydrophilic (water contact angle is 61.28°) while the COF structure is intrinsically hydrophobic (water contact angle is 134.40°), the interpenetrating network within COF/cPI membranes (Water contact angle is 77.69°) is likely to possess unique Janus characteristics. Meanwhile, the isoelectric point shifts from pH 3.8 to pH 7.9 (FIG. 4c), indicating that the COF/cPI membrane has a relatively positive-charge surface in a neutral pH environment. This positively charged surface may result from the unreacted amine groups of TAPA molecules. Table 3 compares their mechanical properties before and after the COF synthesis. The COF/cPI membrane has higher tensile properties and burst pressure than the cPI substrate, implying the former is more mechanically robust than the latter. The enhanced mechanical properties may arise from (i) the strong TT-TT interaction between cPI and COF molecules and (ii) the formation of an interpenetrating polymer network (J. Membr. Sci., 2019, 576, 116-122; Nat. Sustain, 2020, 3, 29-34; Chem. Eng. J., 2020, 387, 124071).

TABLE 3
Mechanical properties and burst pressures of
the cPI substrate and COF/cPI composite HFMs.

| | Tensile strain | Maximum | Young's | Burst |
|---|---|---|---|---|
| Membrane | at maximum | tensile | modulus | pressure |
| ID | elongation (%) | stress (MPa) | (MPa) | (bar) |
| cPI | 5.74 ± 1.47 | 7.00 ± 1.34 | 347.55 ± 7.81 | 13.50 ± 3.00 |
| 8M-COF- | 6.46 ± 1.73 | 9.73 ± 1.68 | 409.28 ± 7.93 | 21.00 ± 2.00 |
| 240 | | | | |

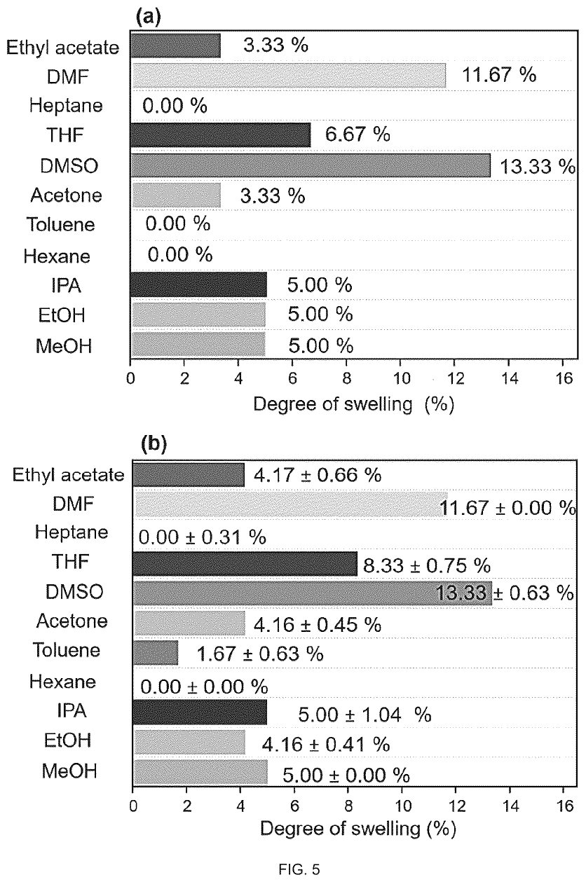

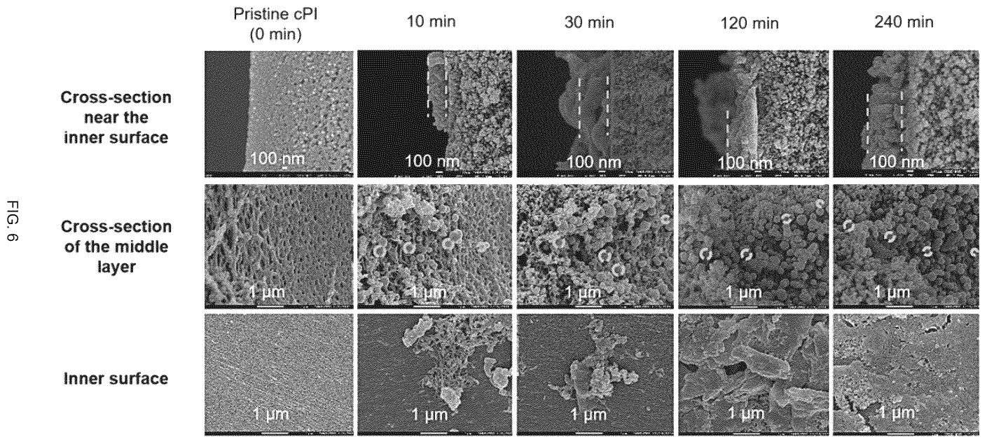

FIG. 5 shows the degrees of swelling of COF/cPI HFMs in various organic solvents after 7 days of immersion and demonstrates good stability. The membranes do not exhibit any delamination or decomposition in all organic solvents. Except in THF, DMSO and DMF, the membranes display dimensional changes of ≤5% after 7-day immersion in various solvents. They have smaller swelling degrees in nonpolar solvents (i.e., toluene, heptane and hexane) than in polar protic solvents (i.e., MeOH, EtOH and IPA). However, they swell seriously in polar aprotic solvents (i.e., DMF, acetone, THF, ethyl acetate and DMSO). DMF and DMSO cause the highest degrees of swelling possibly because of good interaction between these polar aprotic solvents and the amine cross-linked polyimide (Appl. Surf. Sci., 2019, 473, 1038-1048; Polyimide and Polyetherimide Organic Solvent Nanofiltration Membranes, Doctoral Dissertation, University of Nova de Lisboa, 2007; J. Membr. Sci., 2007, 301, 3-10). It is also worth noting that the solvent-induced swelling of a membrane may not always be a disadvantage to its separation performance. As long as the membrane is stable and shows no further dimensional change, solvent treatment is an effective way in improving and stabilizing its separation ability through the solvent-induced polymer rearrangement. Since the swelling ratios of the newly developed HFMs do not change much as a function of time, indicating their good stability in these organic solvents.

### Example 3. Effects of Reaction Duration on HFM Structure and Solvent Separation Performance

The synthesis duration and monomer concentration are important parameters for COF growth.

### Pore Size Distributions

The pore size distribution and effective mean pore size of the hollow fibre support and COF/cPI composite membranes were evaluated by a series of rejection experiments using neutral solutes. In general, 200 ppm PEG or PEO solutions were firstly prepared in DI water as the feeds and then pumped through the lumen side of HFMs at a transmembrane pressure of 1 bar and a flowrate of 1.0 L/min. A total organic carbon analyser (TOC, ASI-5000A, Shimadzu, Japan) were used to measure the concentrations of the feed (C_{f}) and permeate (Cₚ). Thus, the effective rejection R (%) of each solute could be calculated using the following equation (Eq. (2)).

$$R = ( 1 - \frac{{C}_{p}}{{C}_{f}} ) \times 100 \% \qquad ( 2 )$$

Literatures have shown that the solute rejection could be plotted against the Stoke diameter on a log-normal probability graph and the Stoke diameters (dₛ, nm) of PEG and PEO solutes and their molecular weights (M_{W}) followed the correlations as Eq. (3) and Eq. (4), respectively (Chem. Eng. Res. Des., 1998, 76, 885-893; Water Res., 2002, 36, 1360-1368).

$${d}_{s} = 33.46 \times {10}^{- 12} \times {M}_{w}^{0.557} ( {M}_{w} \leq 35 , 000 ) \qquad ( 3 )$$

$${d}_{s} = 20.88 \times {10}^{- 12} \times {M}_{w}^{0.587} ( {M}_{w} \geq 100 , 000 ) \qquad ( 4 )$$

Therefore, one could express the pore size distribution by the following probability density function as Eq. (5) (Chem. Eng. Res. Des., 1998, 76, 885-893; Water Res., 2002, 36, 1360-1368; Appl. Surf. Sci., 2019, 473, 1038-1048):

$$\frac{dR ( {d}_{p} )}{{dd}_{p}} = \frac{1}{{d}_{p} ln {σ}_{p} \sqrt{2 π}} exp [ - \frac{{( ln {d}_{p} - ln {μ}_{p} )}^{2}}{2 {( ln {σ}_{p} )}^{2}} ] \qquad ( 5 )$$

where dₚ is the pore diameter (nm), μₚ is the mean effective pore size (nm) at R=50% and σₚ is determined by the ratio of the pore diameter at R=84.13% over the one at R=50%.

### Organic Solvent Nanofiltration (OSN) Tests

A solvent-resistant stainless steel crossflow setup was used. Prior to the OSN tests, the HFM modules were immersed in the target solvents for 24 hours. One HFM module contained 4 pieces of hollow fibres with an effective length of 22 cm, and its effective membrane area was approximately 0.44 cm². Pure solvents or solute-containing organic solvent solutions were pumped through the lumen side of the hollow fibres at a pressure of 1 bar and a flowrate of 100 mL/min at room temperature (i.e., 22° C.) in order to minimize the fouling influence and mimic the industrial process. 1-hour and 4-hour conditioning were implemented when collecting data from solute/solvent and pure solvent systems, respectively. Moreover, a longer conditioning was employed for pure solvent tests because it took time to fully replace the previous testing solvent within HFMs by the new solvent. At least two independent hollow fibre modules made from the same fabrication procedure were tested. Solvent permeance (L m⁻² h⁻¹ bar⁻¹) was calculated using Eq. (6), three consecutive permeates were measured in order to guarantee reproducibility and their average values were reported.

$$P = \frac{{Q}_{V}}{{A}_{m} Δ P} \qquad ( 6 )$$

where Qᵥ indicates the volumetric flowrate (Lh⁻¹) of the permeate solvent, Aₘ represents the effective hollow fibre filtration area (m²), and ΔP denotes the transmembrane pressure (bar).

The solute concentration in each organic solution during rejection tests was fixed at 50 ppm. The solute rejection was calculated by Eq. (2). Besides, a feed solution consisting of L-α-lecithin with a concentration of 2000 ppm and hexane was also filtered through the optimal membrane. This test was to explore if the newly developed HFMs could be used for practical industrial applications. L-α-lecithin is a well-known food additive that commonly uses hexane to extract from edible oils by a solvent removal process.

For the mixed solute separation tests, the feed solution was prepared by mixing a 50 ppm FGF/IPA solution and a 50 ppm EY/IPA solution together. The dye concentrations in different organic solvents were measured by a UV-Vis spectrometer (Pharo 300, Merck). The molecular weight cut-off (MWCO) was determined when R=90%.

### Ultraviolet-Visible (UV-Vis) Spectroscopy

Examining the absorbance of tested dyes over the visible spectrum, the highest absorbance wavelength (i.e., maximum absorbance wavelength) was found. By graphing the versus concentration of several known solutions, a linear calibration curve for the tested dye was made. Then dye concentration of the unknown sample can be determined from the equation of the line. Three consecutive data with the same volume were measured to ensure the variation is within 5%.

### Results and Discussions

FIG. 6 shows the evolution of membrane morphology as a function of reaction duration for 8M-COF membranes. The aforementioned irregular-shaped films and discrete spherical crystallites are observed on the inner surface and the cross-section of the HFM, respectively, after a 10-minute reaction. More globoid crystallites can be detected when the reaction duration reaches 240 minutes. In contrast, the irregular-shaped films on inner surfaces become larger and thicker, but they cannot fully cover the inner surface. A few holes are still noticed. Since both O concentration and O/N ratio of COF/cPI membranes decrease with an increase in reaction duration (Table 2), this suggests that more COFs are formed on the cPI matrix when prolonging the reaction duration.

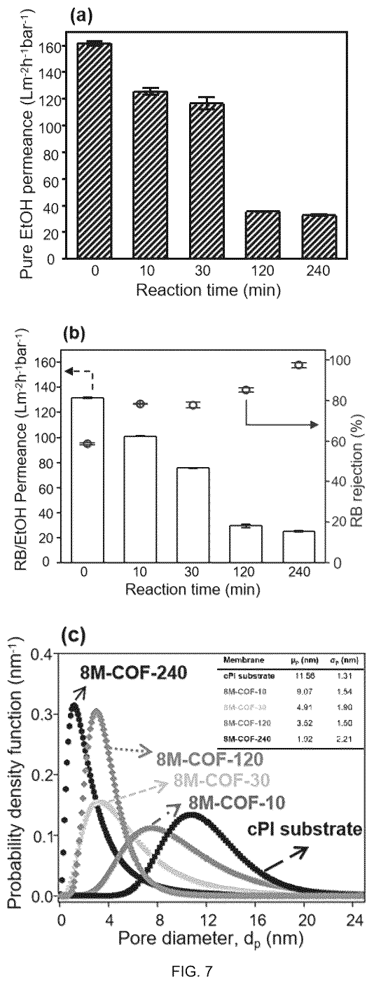

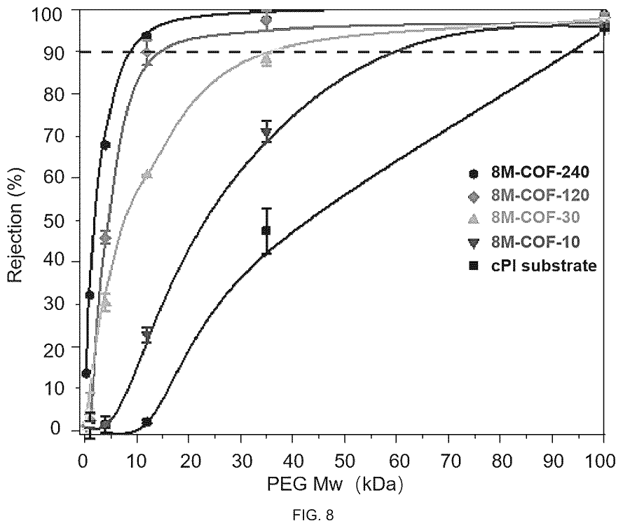

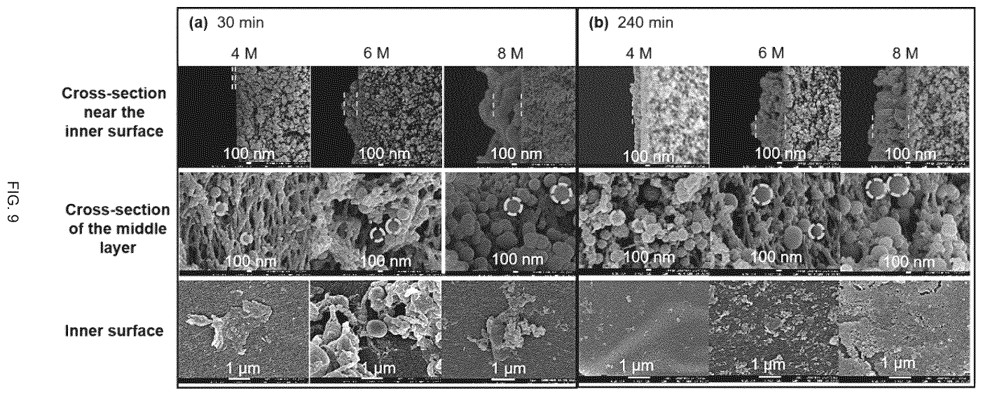

Consistent with the morphological changes of 8M-COF membranes with an increase in reaction duration, FIG. 7a and FIG. 7b show that the permeance of pure EtOH decreases while the rejection of rose bengal (RB) increases with reaction duration. The 8M-COF-240 membrane has an impressive RB (M_{W}=1018 gmol⁻¹) rejection of 97.41% in EtOH, suggesting it is a nanofiltration (NF) membrane. Additional rejection experiments using nonionic polyethylene glycols (PEGs) and polyethylene oxides (PEOs) as solutes reveal the membrane internal structure changes with the unidirectional diffusion and convection reaction duration. As shown in FIG. 7c, the mean effective pore size of 8M-COF membranes in aqueous systems decreases and the pore size distribution becomes sharper with an increase in reaction duration. The sharp pore size distribution is indicative of forming a tighter interpenetrating network within HFMs consisting of a more ordered honeycomb COF structure (Sci. Adv., 2020, 6, eabb1110). The PEG and PEO rejection curves can be found in FIG. 8. It is worth noting that the membrane pore structure in aqueous and non-aqueous systems may be different due to dissimilar solvent-induced swelling and various interactions among the solute, membrane and solvent (Chem. Soc. Rev., 2008, 37, 365-405; Front. Chem., 2018, 6, 511; J. Membr. Sci., 2018, 549, 550-558; J. Chem. Technol. Biotechnol., 2018, 93, 2281-2291; Macromol. Chem. Phys., 2003, 204, 510-521).

The 8M-COF-240 membrane has not only a quite narrow pore size distribution but also a mean effective pore size of 1.92 nm, which is slightly larger than the simulated aperture sizes (i.e., 1.24˜1.37 nm) of TAPA-BTCA frameworks (Sci. Adv., 2020, 6, eabb1110; CrystEngComm, 2017, 19, 4899-4904). This small difference between the mean effective pore size of the membrane and the aperture size of COFs arises from the fact that the membrane has both hydrophilic and hydrophobic pores, and the hydrophilic pores become smaller when more crystallites are intergrown within the cPI matrix. Interestingly, the 8M-COF-30 membrane exhibits a lower EtOH permeance but a slightly lower RB rejection than the 8M-COF-10 membrane. This surprising phenomenon may result from stronger electrostatic interactions between the positively charged COF film (FIG. 4c) and negatively charged RB (Table 4) that facilitates RB permeation. However, once the pore size becomes sufficiently small with an increase in reaction duration, the facilitated RB transport is mitigated because the rejection mechanism is dominated by size exclusion or steric hindrance (J. Membr. Sci., 2007, 301, 3-10; J. Membr. Sci., 2017, 541, 205-213).

In summary, the COF growth can be quickly noticed on both the inner surface and inside the cross-section of HFMs within 10 minutes. A longer reaction duration results in HFMs with a smaller mean effective pore size and a higher dye rejection. A reaction duration of 4 hours at room temperature can tune the pores of HFMs from an ultrafiltration (UF) to a NF range. The formation of the interpenetrating network within the COF/cPI composite membrane may accelerate the reduction of membrane pore size and narrow the pore size distribution of the entire composite membrane.

### Example 4. Effects of Reactant Concentration on COF/cPI Structure and Solvent Separation Performance

By using method described in Example 2, the morphologies of COF/cPI HFMs synthesised under different monomer concentrations for 30 and 240 minutes at room temperature were compared (FIG. 9). Generally, they have similar structural features, but an increase in monomer concentration results in thicker irregular-shaped and discontinuous films on the inner surface. In addition, the size of spherical crystallites in the middle of HFMs increases from ˜200 nm to 250 and 300 nm and their quantity also rises with a higher monomer concentration. Clearly, higher BTCA and TAPA concentrations favour the COF growth.

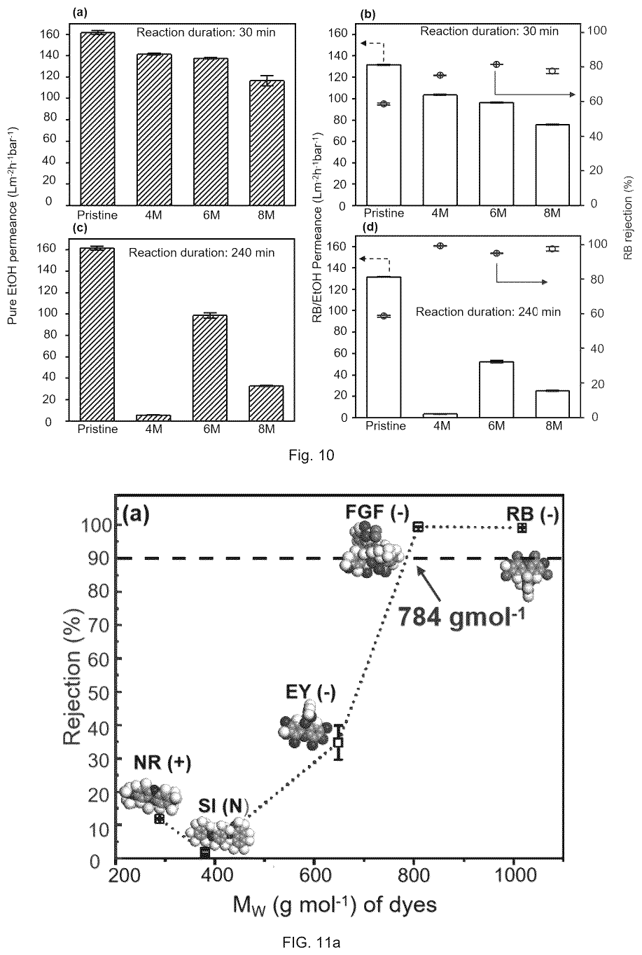

The performance of the pristine cPI substrate and COF/cPI HFMs in the EtOH system were compared (FIG. 10) using method described in Example 3, where the HFMs are synthesized from different concentrations of BTCA and TAPA. The cPI substrate has an extremely high pure EtOH permeance of 161.65 L m⁻² h⁻¹ bar⁻¹ but a low RB rejection of 58.68%. In contrast, the COF-30 minutes membranes synthesized from monomer concentrations of 4-8 M possess high RB rejections up to 81.44% but slightly lower pure EtOH permeances of 116.59-141.28 L m⁻² h⁻¹ bar⁻¹.

To further increase the rejection, a longer reaction duration of 240 minutes is explored. When the reactant concentration is 4 mmol/L, the 4M-COF-240 sample has a surprisingly low pure EtOH permeance of 5.46 L m⁻² h⁻¹ bar⁻¹ but with a RB rejection of almost 100%. However, the pure EtOH permeance of the 6M-COF-240 membrane sharply jumps to 98.44 L m⁻² h⁻¹ bar⁻¹, while the RB rejection remains 94.91%. A further increase in reactant concentration to 8 mmol/L, the pure EtOH permeance of the 8M-COF-240 sample drops to 32.74 L m⁻² h⁻¹ bar⁻¹ and its rejection increases to 97.41%.

The morphological changes with reactant concentration shown in FIG. 9b may be able to explain the above phenomena. For 4M-COF-240, a smooth and ultrathin COF layer is grown on the inner surface of the cPI substrate that almost completely covers the inner surface, while the low monomer concentration results in many small COF crystallites intergrown within the cross-section that limits the channels for solvent transport. The situation changes when the monomer concentration is increased to 6 and 8 mmol/L. Both resultant membranes have thick, irregular and discontinuous COF films on the inner surfaces that cannot fully cover the inner surfaces. In addition, the spherical COF crystallites have bigger sizes in the cPI matrix that creates pathways for solvent transport. Since 6M-COF-240 has a thinner inner surface and more irregular and discontinuous COFs films than 8M-COF-240, the former has the highest solvent permeance with a comparable RB rejection. In general, a higher COF surface density exhibits a higher rejection of RB. It is worth to note although the COF surface density of 6M-COF-240 is relatively low, it still offers a comparable RB rejection. This is because the formation of the interpenetrating network, consisting of COFs and cPI polymer chains, narrows the pore size of the entire composite membrane. Hence, 6M-COF*240 is selected for the subsequent studies in different organic solvent or solute systems.

### Example 5. Separation Performance of 6M-COF-240 HFMs in Various Organic Solvent Systems

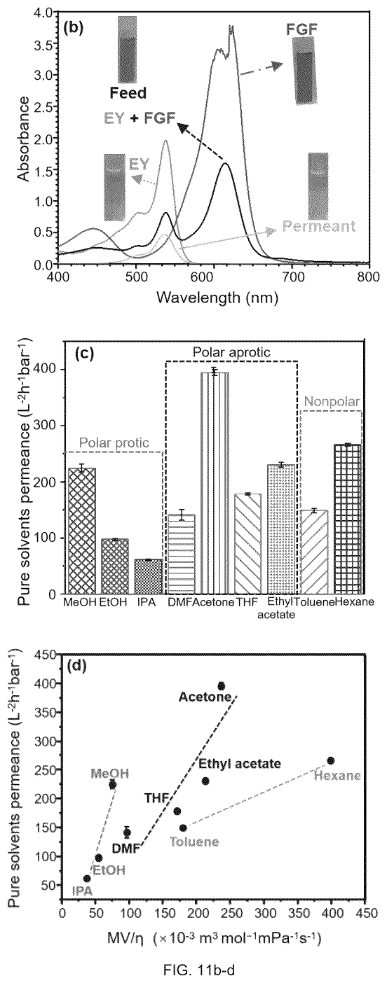

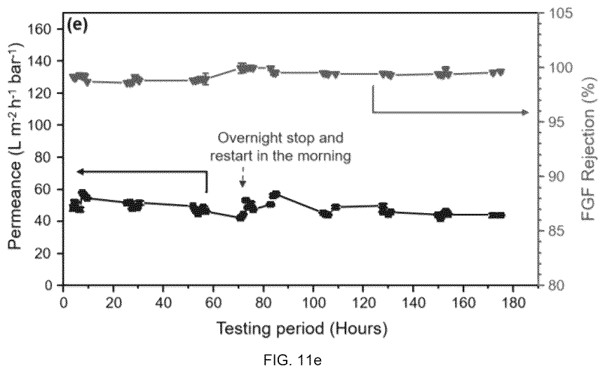

Five dyes with various molecular weights and structures tabulated in Table 4 were dissolved in IPA at 50 ppm and utilized as feeds to study the separation performance of the optimal in situ grown COF/cPI HFMs. In addition, nine organic solvents were chosen to investigate the relationship between transport behaviour and solvent properties across these HFMs. FIG. 11a shows the rejection as a function of dye's molecular weights (M_{W}). The rejections follow the sequence of fast green FCF (FGF)>rose bengal (RB)>eosin Y (EY)>neutral red (NR)>Sudan IV (SI), which is consistent with the order of dyes' spatial sizes (i.e., molecular volumes) rather than M_{W}. The MWCO of 6M-COF-240 is about 784 gmol-1 in IPA. Since the rejection curve has an S-shape, the membranes have great potential for precise separation of small molecules with a certain shape or size (Nat. Commun., 2020, 11, 5323; Sci. Adv., 2020, 6, eabb3188). These results reconfirm that molecular sieving and steric hindrance are the major separation mechanisms for COF/cPI HFMs in the dye/IPA system (Appl. Surf. Sci., 2019, 473, 1038-1048; Sci. Adv., 2020, 6, eabb3188; ACS Appl. Mater. Interfaces, 2019, 11, 36717-36726). Although COF/cPI membranes may have a slightly positively charged surface (FIG. 4c), their rejection against positively charged NR is only 11.83%. This is because NR has a small molecular size and a very slender shape. Thus the Donnan effect on separation becomes relatively weak. To evaluate the precise molecular sieving capability of 6M-COF-240 HFM, it was applied to separate a mixture consisting of two different solutes; namely, FGF (simulated MV=1348 Å³, M_{W}=809 gmol⁻¹) and EY (simulated MV=679 Å³, MW=648 gmol⁻¹). The feed mixture has a blue colour in IPA, while the permeant shows a light orange color, as shown in FIG. 11b. The UV absorption spectra confirm that the 6M-COF-240 membrane completely removes FGF, while EY solutes can freely pass through the membrane, signalling the COF/cPI composite HFM discriminates molecules with similar M_{W} but different shapes. The outstanding capability for shape selectivity of the membranes can be attributed to molecular sieving and steric hindrance of the IPN.

FIG. 11c shows the pure solvent permeances of 6M-COF-240 HFMs as a function of solvent type and properties. Table 5 tabulates the physical characteristics of these solvents. In FIG. 11d, the order of pure solvent permeances follows: (i) for polar protic solvents, MeOH>EtOH>IPA; (ii) for polar aprotic solvents, acetone>ethyl acetate>THF>DMF; and (iii) for nonpolar solvents: hexane>toluene. For each type of organic solvents, all permeances increase with an increase in MVₛ ηs⁻¹, a combined term from solvent molar volume (MVₛ) and solvent viscosity (ηₛ). Generally, the 6M-COF-240 HFMs have extraordinary permeances for both polar and nonpolar solvents (e.g. MeOH: 224.28 L m⁻² h⁻¹ bar⁻¹, acetone: 395.21 L m⁻² h⁻¹ bar⁻¹ and hexane: 266.27 L m⁻² h⁻¹ bar⁻¹) because their selective layer in the penetrating network has low polar inner cavities from COFs and high polar channels from cPI for solvent transport.

TABLE 5
Physical properties of various solvents.

| | M_{Ws} ^{a)} | d_{K, s} ^{b)} | MVₛ ^{c)} | ηₛ ^{d)} | δₛ ^{f)} | | MVₛ/ηₛ |
|---|---|---|---|---|---|---|---|
| Solvent | (g mol⁻¹) | (nm) | (×10⁻³ m³ mol⁻¹) | (mPa · s) | (MPa^{1/2}) | Pₛ ^{g)} | (Pa⁻¹m³s⁻¹) |
| MeOH | 32.04 | 0.38 | 40.4 | 0.54 | 12.3 | 0.762 | 74.81 |
| EtOH | 46.0 | 0.43 | 58.8 | 1.08 | 8.8 | 0.654 | 54.44 |
| IPA | 60.1 | 0.47 | 76.8 | 2.05 | 6.1 | 0.546 | 37.46 |
| DMF | 73.1 | 0.55 | 77.1 | 0.80 | 13.7 | 0.386 | 96.38 |
| Acetone | 58.08 | 0.47 | 73.3 | 0.31 | 10.4 | 0.355 | 236.45 |
| Ethyl acetate | 88.11 | 0.52 | 97.8 | 0.46 | 5.3 | 0.228 | 212.61 |
| THF | 72.1 | 0.49 | 81.2 | 0.48 | 8 | 0.207 | 171.04 |
| Toluene | 92.14 | 0.57 | 106.3 | 0.59 | 1.4 | 0.099 | 180.17 |
| Hexane | 86.2 | 0.43 | 131.4 | 0.33 | 0 | 0.009 | 398.18 |

^{a)} M_{Ws} is the molecular weight of a solvent;
^{b)} d_{K, s} is the kinetic diameter of a solvent;
^{c)} MVₛ is the molar volume of a solvent;
^{d)} ηₛ is the dynamic viscosity of a solvent;
^{f)} δ_{p, s} is the Hansen solubility parameter for the polarity of a solvent; and
^{g)} Pₛ is the relative polarity of a solvent.

Table 6 shows the comparison of the permeances between 6M-COF-240 HFMs and other polymeric membranes in the literature for nonpolar solvents. The newly developed membrane exhibits much higher solvent permeances than commercial and other lab-scale polymeric OSN membranes. For polar solvents such as acetone, it has an acetone permeance of about 130 times higher than the commercially available polyimide-based OSN membranes (e.g. DuraMem 500 shows an acetone permeance of 2.99 L m⁻² h⁻¹ bar⁻¹ with a similar molecular weight cut-off (MWCO), whose rejection of glyceryl trilinoleate (M_{W}=880 gmol⁻¹) is 92.6%, J. Membr. Sci., 2019, 588, 117202). Table 6 benchmarks the solvent separation performance for various alcohol systems between 6M-COF-240 and other polymeric solvent-resistant HFMs in the recent literature. The COF/cPI composite HFMs have solvent permeances far superior to the state-of-the-art polymeric solvent-resistant HFMs yet with comparable dye rejections.

TABLE 6
Benchmark of solvent separation performance of polymeric HFMs published in the last 10 years.

| | Pure solvents | | | | | |
|---|---|---|---|---|---|---|
| | permeance | | | Rejection | Operating | |
| Membrane | (L m⁻² h⁻¹ bar⁻¹) | | Solute (M_{w}) | (%) | pressure (bar) | Ref. |
| Polyamide with PEG600 | MeOH | 0.32 | VB₁₂ | 97.7 | 3 | [1] |
| | | | (1355) | | | |
| PPSU 22.5 HFM | IPA | 0.19 | Rose Bengal (1018) | 98.6 | 5 | [2] |
| TA modified PAN | MeOH | 1.28 | Evans Blue | 100 | 3 | [3] |
| | | | (961) | | | |
| Crosslinked PAN-8 h | EtOH | 6.85 | Rose Bengal (1018) | 93.1 | | |
| Crosslinked PAN-18 h | EtOH | 2.32 | Remazol Brilliant Blue R | 99.9 | 2 | [4] |
| | | | (627) | | | |
| NH₂-MWCNT/P84 | EtOH | 1.17 | Brilliant blue R (826) | 99.9 | 5 | [5] |
| Cellulose HFM | EtOH | 6 | Congo Red (696) | 90 | 0.2 | [6] |
| SFPS dual-layer | MeOH | 0.83 | Remazol Brilliant Blue R | 99.3 | 16 | [7] |
| Matrimid polyimide | | | (627) | | | |
| PBI-H₂SO₄ | MeOH | 3.5 | Tetracycline (444) | 98 | 5 | [8] |
| 6M-COF-240 | Hexane | 266.27 | L-α-lecithin (758) | ~100 | 1 | This |
| | Acetone | 395.21 | Fast green FCF (809) | 98.9 | | work |
| | EtOH | 98.44 | Rose Bengal (1018) | 92 | | |
| | IPA | 61.68 | Rose Bengal (1018) | 99.1 | | |
| | | | Fast green FCF (809) | 99.5 | | |

Ref.:
[1] RSC Adv., 2018, 8, 19879-19882;
[2] J. Membr. Sci., 2011, 384, 89-96;
[3] J. Membr. Sci., 2020, 610, 118294;
[4] J. Membr. Sci., 2017, 542, 289-299;
[5] Chem. Eng. J., 2018, 345, 174-185;
[6] J. Membr. Sci., 2019, 586, 151-161;
[7] Chem. Eng. Sci., 2015, 129, 232-242; and
[8] J. Membr. Sci., 2019, 572, 580-587.

To further validate the membrane separation mechanism, a long-term separation test excluding the possible influence by absorption was investigated. FIG. 11e plots the permeance and rejection of 6M-COF-240 HFMs as a function of time in a crossflow test using an IPA feed containing 50 ppm FGF under 1 bar. The permeance is stable with a variation of ±15%, inferring negligible fouling and acceptable membrane compaction during the 175-hour test. This is because a very low transmembrane pressure of 1 bar was used during the entire test. The slight permeance increase at 72 hours may result from the pressure release during the overnight stop and restart in the morning for safety reasons in the end of the third day. However, the FGF rejection remains steady up to approximately 99% within the first 3 days. A slight rejection enhancement afterward may be due to the membrane compaction. In summary, the in situ grown COF/cPI HFMs exhibit a stable permeance and an excellent rejection in a long-term test up to 7 days. Although molecule sieving and absorption may both happen during separation, the former mechanism is dominant in the FGF-IPA system.

Comparing to the commercially available solvent-resistant membranes, the newly developed HFMs have far superior permeances in both polar and nonpolar solvents but with comparable rejections. A unique interpenetrating network consisting of COFs with hydrophobic pores and cPI with hydrophilic pores is formed within the COF/cPI HFMs in less than 4 hours at room temperature and atmospheric pressure. Additionally, the novel COF/cPI composite HFMs can be easily operated under a low operating pressure with less fouling and membrane compaction. A new strategy to grow COFs on porous polymeric hollow fibre substrates with Janus-like pore characteristics is hereby provided. It also demonstrates a new type of solvent-resistant HFMs with super high fluxes and tunable pore sizes for OSN that can be operated under low pressures with great potentials for practical industrial applications due to significant energy saving and reduction of operational costs. Last but not least, membrane fouling mitigation achieves sustainable membrane performance.

1. A composite membrane material, comprising:
a cross-linked polymeric hollow fibre substrate having an inner lumen surface, an outer shell surface and an interior portion between the inner lumen surface and the outer shell surface;
a plurality of discontinuous covalent organic framework films on the inner lumen surface of the cross-linked polymeric hollow fibre substrate; and
a plurality of spherical covalent organic framework nanoparticles in the interior portion of the polymeric hollow fibre substrate,
wherein the cross-linked polymeric hollow fibre substrate is formed from a polyimide; and
wherein the cross-linked polymeric hollow fibre substrate has an average pore size of 20 nm or less.

2. The composite membrane material according to claim 1, wherein the covalent organic framework films and the plurality of spherical covalent organic framework nanoparticles are formed from an imine covalent organic framework that is formed from an aldehyde component and an amino component.

3. The composite membrane material according to claim 2, wherein the aldehyde component is selected from one or more of the group consisting of 1,3,5-triformylbenzene, 1,3,5-tris(p-formylphenyl)benzene, benzene-1,3,5-tricarboxaldehyde, and terephthalaldehyde.

4. The composite membrane material according to claim 2, wherein the amino component is selected from one or more of the group consisting of p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, and melamine.

5. The composite membrane material according to claim 2, wherein the aldehyde component is benzene-1,3,5-tricarboxaldehyde (BTCA) and the amino component is tris(4-aminophenyl)amine (TAPA).

6. The composite membrane material according to claim 1, wherein the plurality of spherical covalent organic framework nanoparticles in the interior portion of the polymeric hollow fibre substrate are located in a region that is from 20 to 50 μm from the inner lumen surface of the cross-linked polymeric hollow fibre substrate.

7. The composite membrane material according to claim 1, wherein the plurality of covalent organic frameworks in the interior portion of the polymeric hollow fibre substrate form an interpenetrating network with the polyimide that forms the cross-linked polymeric hollow fibre substrate.

8. The composite membrane material according to claim 1, wherein the composite membrane material has a water contact angle of from 65 to 100°.

9. The composite material according to claim 1, wherein the composite membrane material has one or more of the following properties:
(a) a molecular weight cut-off of from 500 to 2000 g/mol;
(b) a rejection of from 80 to 100% to rose bengal;
(c) an ethanol permeance of from 50 to 200 L m⁻² h⁻¹ bar⁻¹;
(d) a methanol permeance of from 50 to 300 L m⁻² h⁻¹ bar⁻¹;
(e) an acetone permeance of from 100 to 800 L m⁻² h⁻¹ bar⁻¹;
(f) a hexane permeance of from 50 to 400 L m⁻² h⁻¹ bar⁻¹;
(g) an isopropyl alcohol permeance of from 30 to 100 L m⁻² h⁻¹ bar⁻¹;
(h) a dimethylformamide permeance of from 30 to 120 L m⁻² h⁻¹ bar⁻¹;
(i) a tetrahydrofuran permeance of from 150 to 260 L m⁻² h⁻¹ bar⁻¹;
(j) an ethyl acetate permeance of from 100 to 300 L m⁻² h⁻¹ bar⁻¹;
(k) a toluene permeance of from 80 to 200 L m⁻² h⁻¹ bar⁻¹; and
(l) a pore size distribution of from 0.5 to 4.0 nm.

10. A method of forming a composite membrane material as described in claim 1, the method comprising:
(a) providing one or more hollow fibres in a hollow fibre module, where each hollow fibre is a cross-linked polymeric hollow fibre formed from a polyimide and has an inner surface, an outer surface and an interior portion between the inner surface and the outer surface;
(b) simultaneously circulating:
(i) a first solution comprising an organic solvent and a first covalent organic framework precursor through the lumen side of the hollow fibre module (inner surface of each of the hollow fibres); and
(ii) a second solution comprising water and a second covalent organic framework precursor over the shell side of the hollow fibre module (outer surface of each of the hollow fibres),
for a period of time to form the composite material.

11. The method according to claim 10, wherein the first and second covalent organic framework precursors form an imine covalent organic framework, where the first covalent organic framework precursor is a molecule comprising an aldehyde group and the second covalent organic framework precursor is a molecule comprising an amino group.

12. The method according to claim 11, wherein the molecule comprising an aldehyde group is selected from one or more of the group consisting of 1,3,5-triformylbenzene, 1,3,5-tris(p-formylphenyl)benzene, benzene-1,3,5-tricarboxaldehyde, and terephthalaldehyde.

13. The method according to claim 11, wherein the molecule comprising an amino group is selected from one or more of the group consisting of p-phenylenediamine, 4,4′-diaminobiphenyl, tris(4-aminophenyl)amine, 1,3,5-tris(4-aminophenyl)benzene, 2,4,6-tris(4-aminophenyl)-s-triazine, triaminoguanidinium chloride, and melamine.

14. The method according to claim 11, wherein the molecule comprising an aldehyde group is benzene-1,3,5-tricarboxaldehyde (BTCA) and the molecule comprising an amino group is tris(4-aminophenyl)amine (TAPA).

15. The method according to claim 11, wherein the period of time is from 10 minutes to 360 minutes.

16. The method according to claim 10, wherein the concentration of the first and second covalent organic framework precursors in the first and second solvents, respectively, is from 4 mmol/L to 8 mmol/L.

17. The method according to claim 10, wherein the concentration of the first and second covalent organic framework precursors in the first and second solvents, respectively, is about 6 mmol/L and the period of time is about 240 minutes.

18. A method of using a composite membrane material as described in claim 1 in a process of separating a fluid into a filtrate fluid and a retentate fluid, the process comprising the steps of:
(a) providing a fluid in need of separation to a hollow fibre module comprising a plurality of hollow fibres of the composite membrane material as described in claim 1;
(b) enabling a portion of the fluid to pass through the composite membrane material by applying a pressure differential across the composite membrane material to provide a filtrate fluid and thereby providing a retentate fluid; and
(c) collecting the filtrate fluid and retentate fluids.

19. The method according to claim 18, wherein the fluid to be separated is selected from: an aqueous solution comprising one or more inorganic materials; an aqueous solution comprising one or more organic materials; an aqueous solution comprising one or more inorganic materials and one or more organic materials; a mixture of organic liquids; a mixture of one or more organic liquids and water; a mixture of one or more organic liquids and one or more organic materials; a mixture of one or more organic liquids and one or more inorganic materials; a mixture of one or more organic liquids, one or more organic materials and one or more inorganic materials; a mixture of water, one or more organic liquids and one or more organic materials; a mixture of water, one or more organic liquids and one or more inorganic materials; and a mixture of water, one or more organic liquids, one or more organic materials and one or more inorganic materials.
